(19) United States
(12) Patent Application Publication
(10) Pub. No.: US 2025/0231442 A1
(43) Pub. Date: Jul. 17, 2025

(54) TRANSMITTANCE-VARIABLE LIQUID CRYSTAL CELL IN WHICH QUANTITY OF LIQUID CRYSTALS FILLED THEREIN IS ADJUSTED AND METHOD OF MANUFACTURING TRANSMITTANCE-VARIABLE LIQUID CRYSTAL CELL

(71) Applicant: Optiple Inc., Cheongju-si (KR)

(72) Inventors: In-seok HWANG, Daejeon (KR); I-tai KWON, Anseong-si (KR); Ji-hyung LEE, Yongin-si (KR)

(73) Assignee: Optiple Inc., Cheongju-si (KR)

(21) Appl. No.: 18/986,861

(22) Filed: Dec. 19, 2024

(30) Foreign Application Priority Data
Jan. 16, 2024 (KR) 10-2024-0006863

(51) Int. Cl. G02F 1/1339; G02F 1/1333; G02F 1/1335; G02F 1/1341

(52) U.S. Cl. CPC G02F 1/1339; G02F 1/133351; G02F 1/133528; G02F 1/1341

(57) ABSTRACT

Disclosed are a transmittance-variable liquid crystal cell and a method of manufacturing a transmittance-variable liquid crystal cell. An internal space of the liquid crystal cell partitioned by a sealant line includes a main filling area and a bank for liquid crystal injection that communicates with the main filling area, wherein the internal space of the liquid crystal cell that is partitioned by the sealant line having a closed curve shape is initially filled with a filling rate of less than 100%.

### CROSS REFERENCE TO PRIOR APPLICATION

This application claims priority to Korean Patent Application No. 10-2024-0006863 filed on Jan. 16, 2024, which is hereby incorporated by reference in its entirety.

### BACKGROUND

The present disclosure relates to a transmittance-variable liquid crystal cell and a method of manufacturing the transmittance-variable liquid crystal cell, and more particularly, to a transmittance-variable liquid crystal cell in which an agglomeration stain does not occur in liquid crystals within the liquid crystal cell or a liquid crystal dye mixture although the transmittance-variable liquid crystal cell is applied to an inner curved surface of the base of a curved optical instrument and in which bubbles are not generated within the transmittance-variable liquid crystal cell due to the long-term shortage of the quantity of liquid crystals, a liquid crystal film cell including the transmittance-variable liquid crystal cell, and a method of manufacturing the same.

A transmittance-variable liquid crystal film cell means a complex film which can change the transmittance of electromagnetic waves, such as a visible ray that passes through the transmittance-variable liquid crystal film cell depending on whether external electric energy is applied.

The transmittance-variable liquid crystal film cell may include a liquid crystal cell and a functional film which are constructed to control the transmission or blocking of light. The transmittance-variable liquid crystal cell may include two electrode films (e.g., the two electrode films have a structure in which an electrode layer and an orientation layer are formed on a base film) that are disposed to face each other and a liquid crystal layer within a space that is formed by an outskirt sealing part line, that is, a closed curve. Liquid crystals within the liquid crystal cell may be oriented and simultaneously the transmittance of the liquid crystal cell may be changed depending on whether a voltage is applied to the liquid crystal cell. Specifically, a polarizing functional film may be attached to both sides of the liquid crystal cell to utilize the transmission and blocking of polarized light, or a liquid crystal mixed with a dichroic dye may be applied so that the dichroic dye is oriented together with the orientation of the liquid crystal, thereby varying the transmittance.

A transmittance-variable device may be used in a smart window for construction, a sunroof for a vehicle, a side window for a vehicle, a sun visor for a vehicle, a rearview mirror for a vehicle, and a light shield plate for a transparent display because the transmittance-variable device uses the transmission and blocking of light that is introduced from the outside. Furthermore, the transmittance-variable device may also be used for the purpose of improving information visibility in eyewear products, such as a windshield for a bike helmet and a smart eyewear for sports, and an eyewear for augmented reality (AR).

In most of the aforementioned uses, it is advantageous if the transmittance-variable liquid crystal film cell has an optimized structure in which a problem does not occur although it is applied to the curved surface type optical base because the transmittance-variable liquid crystal film cell has to be attached to at least a part of a surface of the curved surface type optical base of an optical device or adjacently disposed along curvature of curved surface type optical base.

In the transmittance-variable liquid crystal cell that is manufactured in the form of a plane, the irregularity of a cell gap may occur within the liquid crystal cell if the transmittance-variable liquid crystal cell is applied to the inside of the curved surface type optical base. In an area in which the cell gap is increased, problems, such as the aggregation of the liquid crystal dye mixture or the formation of bubbles over extended periods may occur. Accordingly, there is a need for a transmittance-variable liquid crystal cell and a liquid crystal film cell product which can fundamentally prevent such as a failure phenomenon.

### PRIOR ART DOCUMENT

### Patent Document

(Patent Document 1) Korean Patent No. 10-0741900 (Jul. 16, 2007)
(Patent Document 2) Korean Patent No. 10-2176231 (Nov. 3, 2020)

### SUMMARY

In a vacuum lamination process that is applied in an implementation example of the present disclosure, if pressure of a liquid crystal cell becomes atmospheric pressure after a mixture of a liquid crystal compound and a dichroic dye is sealed by bonding the liquid crystal cell in a vacuum state, a pressure difference may occur between the inside and outside of the liquid crystal cell. In particular, if the mixture of the liquid crystal compound and the dichroic dye is insufficient, there is a possibility that external air may penetrate the liquid crystal cell due to an air pressure difference between the inside and outside of the liquid crystal cell if the liquid crystal cell is used for a long time. Furthermore, there is always a possibility that a gas and moisture that are melted in the mixture of the liquid crystal compound and the dichroic dye within the liquid crystal cell may form bubbles. Accordingly, in view of reducing the generation of bubbles, it is advantageous that the mixture of the liquid crystal compound and the dichroic dye maintains a filling rate of 100% or more on the basis of the volume of an internal space upon vacuum lamination of the liquid crystal cell. When a flat liquid crystal cell is subjected to curved surfacing, the mixture of the liquid crystal compound and the dichroic dye may be moved because irregular deformation occurs in the internal space in a process of upper and lower substrates being bonded, and as a result, an agglomeration stain may occur in the liquid crystal dye. Furthermore, as the filling quantity of the liquid crystal mixture is more increased, an agglomeration stain occurs in the liquid crystal more easily.

An implementation example of the present disclosure is intended to solve both the problems of an agglomeration stain and bubbles in the mixture of the liquid crystal compound and the dichroic dye when a plane type transmittance-variable liquid crystal cell that has been vacuum-bonded in a plane state is subjected to curved surfacing. In particular, an object of the present disclosure is to provide a method of manufacturing a liquid crystal cell in which the filling rate of the mixture of the liquid crystal compound and the dichroic dye that is filled into a liquid crystal cell is always uniformly adjusted to an optimal level. Furthermore, an object of the present disclosure is to provide a transmittance-variable liquid crystal cell in which all of multiple liquid crystal cells within the original plate of a liquid crystal cell have a uniform liquid crystal filling quantity. Hereafter, “cureved surfacing” means deforming a liquid crystal cell into a curved shape, such as for attachment to curved optical products.

A transmittance-variable liquid crystal cell may be manufactured in a plane form through a vacuum lamination process.

More specifically, a plane type liquid crystal cell may be manufactured by bonding upper and lower substrate films in a vacuum state after predetermined amounts of liquid crystals and a dichroic dye mixture are dispensed on the lower substrate film in which a sealing area in the outskirts of the plane type liquid crystal cell is formed in a closed curve shape by an uncured sealant under atmospheric pressure. In this case, a spacer for constantly maintaining a cell gap may be fixed to any one of the upper and lower substrate films while maintaining an average distance across the entire area of the upper and lower substrate films. Accordingly, total areas of the upper and lower substrate films can be spaced apart from each other by the spacer having a predetermined height even after the vacuum lamination.

The volume of the internal space of the liquid crystal cell may be determined by the internal area of the closed curve on which a sealant line has been drawn and an average height of the spacer. The filling rate of the mixture of the liquid crystal compound and the dichroic dye is the ratio (%) of the volume of the internal space of the liquid crystal cell and the filling quantity (volume) of the mixture of the liquid crystal compound and the dichroic dye that is filled into the volume of the internal space.

The agglomeration of the mixture of the liquid crystal compound and the dichroic dye prominently appears in a liquid crystal cell of a curved surface type optical device to which curved surfacing has been applied. In order to suppress the agglomeration of the mixture of the liquid crystal compound and the dichroic dye from occurring, it is most preferred that the filling rate of the mixture of the liquid crystal compound and the dichroic dye maintains almost 100% in the state in which the curved surfacing has been applied. It is necessary to secure a filling rate of at least 100% or more because the possibility that bubbles are generated is increased in the long term when the filling rate of the liquid crystals is less than 100%. It is very difficult to accurately control the filling

rate of the mixture of the liquid crystal compound and the dichroic dye that is filled into the plane type liquid crystal cell, assuming that the curved surfacing is applied. The cell gap may be reduced because compression occurs in a wide area of the liquid crystal cell in a common process of the plane type liquid crystal cell being curved-surfaced. Furthermore, the internal space of the liquid crystal cell may be changed because the cell gap is increased due to local deformation at a specific location of the liquid crystal cell. Accordingly, it is more difficult to manufacture a liquid crystal cell in which bubbles are not generated and an agglomeration problem also does not occur in the mixture of the liquid crystal compound and the dichroic dye when a curved surface is applied, by optimizing the filling rate of a plane type liquid crystal cell.

Accordingly, in an implementation example of the present disclosure, an internal space of a sealant line that is partitioned by a sealant line, that is, a closed curve, is formed on the liquid crystal cell, and the internal space of the sealant line includes a main filling area and a bank for liquid crystal injection, which communicates with the main filling area. Furthermore, the bank for liquid crystal injection may be exposed to atmospheric pressure by incising one side of the bank so that liquid crystals within the bank for liquid crystal injection are additionally injected into the main filling area. The filling rate of the liquid crystals within the main filling area may be adjusted to a level close to 100% due to a pressure difference between the internal space of the sealant line and the outside, which occurs in this case.

In particular, the internal space of the sealant line, which is partitioned by the sealant line, is divided into the main filling area and the bank for liquid crystal injection, which communicates with the main filling area. The bank for liquid crystal injection may be connected to the main filling area through a communication channel.

A part of the bank for liquid crystal injection may be opened by a method, such as cutting, and may be exposed to atmospheric pressure through the incision part of the bank for liquid crystal injection. The bank for liquid crystal injection, which is exposed to atmospheric pressure through the incision part, controls a movement of the liquid crystals while operating in conjunction with atmospheric pressure, and can move the liquid crystals in a direction in which air pressure is in equilibrium. In this case, according to an implementation example of the present disclosure, when the liquid crystal cell that has been bonded in the vacuum state is monitored under atmospheric pressure, pressure of the internal space of the sealant line on which the liquid crystals have been dispensed is relatively low pressure compared to atmospheric pressure if the quantity of the liquid crystals is insufficient.

Accordingly, when a part of the bank for liquid crystal injection is exposed to atmospheric pressure by incising the bank, the liquid crystals may be additionally injected into the main filling area through the communication channel, and the filling quantity of liquid crystals within the main filling area may be gradually increased and may converge on the filling rate of 100%.

Furthermore, according to an implementation example of the present disclosure, the communication channel between the bank for liquid crystal injection and the main filling area may be closed by a finishing sealant. The finishing sealant may be a liquid phase sealant. After the liquid phase sealant is injected into the bank for liquid crystal injection, the liquid phase sealant that flows into the communication channel may seal the communication channel. That is, in the state in which the bank for liquid crystal injection has been exposed to atmospheric pressure by the incision part and the liquid crystals have been flowing into the main filling area, the liquid phase sealant is injected into the bank for liquid crystal injection before pressure within the liquid crystal cell reaches atmospheric pressure so that the communication channel is sealed by the liquid phase sealant. Accordingly, bubbles may not be collected between the liquid crystals within the liquid crystal cell and the sealing area. The liquid phase finishing sealant may be cured by a method, such as UV curing or heat curing. The cured sealant may close the communication channel between the bank for liquid crystal injection and the main filling area.

As described above, according to an implementation example of the present disclosure, the internal space of the sealant line with which the liquid crystals will be filled is formed as an internal space having an over volume, including the bank for liquid crystal injection in addition to the main filling area. In this case, after the internal space of the sealant line is filled less than 100%, one side of the bank for liquid crystal injection is incised so that the bank for liquid crystal injection is influenced by atmospheric pressure, and the liquid crystals within the bank for liquid crystal injection can be additionally injected into the main filling area. Accordingly, the filling rate of the mixture of the liquid crystal compound and the dichroic dye within the main filling area, that is, within a space that will become an individual transmittance-variable liquid crystal cell by a cutting process, is controlled to a required level, preferably, the 100% level of the filling rate of the liquid crystals. Accordingly, the occurrence of the agglomeration of liquid crystals can be prevented, and the cause of the generation of bubbles can be removed in the long term.

According to the transmittance-variable liquid crystal cell in which the quantity of liquid crystals filled therein is adjusted and the method of manufacturing a transmittance-variable liquid crystal cell according to preferred implementation examples of the present disclosure, the internal space of the sealant line that has been vacuum-bonded and has a closed curve shape is constructed to be divided into the main filling area and the bank for liquid crystal injection. A filling rate (%) within the main filling area can be adjusted by gradually dispensing liquid crystals within the bank for liquid crystal injection to the main filling area by using pressure equilibrium with atmospheric pressure. Accordingly, there is an advantage in that a filling quantity can be controlled so that the filling rate (%) within the main filling area becomes a required level, preferably, in an optimal state close to the filling rate 100%.

According to an implementation example of the present disclosure, control of the filling quantity may be performed in the state in which curved surfacing has been applied. The filling quantity can be optimally controlled based on an effective volume of the internal space in the state in which the curved surfacing has been applied based on various radii of curvature. Accordingly, the present disclosure may be suitable for effectively suppressing the agglomeration of liquid crystals and the generation of bubbles in a curved surface type optical device.

Furthermore, according to an implementation example of the present disclosure, the generation of bubbles can be effectively prevented in the long term because a pressure difference between the inside and outside of the liquid crystal cell is solved.

In particular, in an implementation example of the present disclosure, pressure of liquid crystals within the sealant line including the bank for liquid crystal injection is made pressure lower than atmospheric pressure, and an incision part with an atmospheric pressure environment is formed by incising a part of the bank for liquid crystal injection. The liquid crystals can be additionally injected into the main filling area through the communication channel between the bank for liquid crystal injection and the main filling area due to a pressure difference that is generated at this time. Accordingly, there are advantages in that a process can be simplified because the filling rate (%) of the liquid crystals can be optimally controlled subsequently by a simple process of sealing the communication channel by the finishing sealant, the filling rate (%) of an individual liquid crystal cell is uniform, and a manufacturing cost can be reduced because the agglomeration of the mixture of the liquid crystal compound and the dichroic dye and a failure rate of bubbles can be reduced even without separate test equipment.

### BRIEF DESCRIPTION OF THE DRAWINGS

FIG. 1 is a cross-sectional view exemplarily illustrating a basic structure of a transmittance-variable liquid crystal film cell.

FIG. 2 is a cross-sectional view exemplarily illustrating a detailed structure of a liquid crystal cell in the transmittance-variable liquid crystal film cell of FIG. 1.

FIG. 3 conceptually illustrates a bonding process of attaching a plane type transmittance-variable film cell to an optical product having a curved surface.

FIGS. 4A to 4C diagrammatically illustrate examples in which the agglomeration of liquid crystals occurs in a conventional transmittance-variable liquid crystal cell. FIG. 4A is a plan view of the transmittance-variable liquid crystal cell in which the agglomeration of liquid crystals occurred.

FIG. 4B illustrates a cross section taken along line A-A′ in FIG. 4A. FIG. 4C is an example of a transmittance-variable guest-host liquid crystal cell in which the agglomeration of liquid crystals and a dichroic dye actually occurred.

FIG. 5 illustrates an example of a transmittance-variable liquid crystal cell in which the quantity of liquid crystals filled therein is adjusted, which includes a bank for liquid crystal injection that communicates with a main filling area according to an implementation example of the present disclosure.

FIGS. 6A and 6B illustrate a process of liquid crystals being sequentially injected into the entire area after vacuum lamination. FIG. 6A illustrates an initial injection process of liquid crystals upon vacuum lamination. FIG. 6B illustrates that the mixture of the liquid crystal compound and the dichroic dye disposed on the main filling area is filled toward a bank for liquid crystal injection.

FIGS. 7A to 7D illustrate enlarged parts of the transmittance-variable liquid crystal cell in which the quantity of liquid crystals filled therein is adjusted in FIG. 5 according to an implementation example of the present disclosure. FIG. 7A illustrates the state in which an opening has been formed on one side of the bank for liquid crystal injection. FIG. 7B illustrates the state in which some of liquid crystals within the bank for liquid crystal injection have moved to the main filling area through a communication channel. FIG. 7C illustrates the state in which a liquid phase sealant is injected by forming a second opening on the other side of the bank for liquid crystal injection. FIG. 7D illustrates the state in which an exposed opening of the communication channel has been closed by a finishing sealant after a step of cutting a sealant line.

FIG. 8A and FIG. 8B describe a process of liquid crystals being filled from the main filling area toward the bank for liquid crystal injection within the transmittance-variable liquid crystal cell that has been subjected to vacuum bonded.

FIG. 9A and FIG. 9B describe that liquid crystals are moved toward the main filling area because a pressure difference occurs due to the opening formed on one side of the bank for liquid crystal injection.

### DETAILED DESCRIPTION

Embodiments described hereinafter have been merely described in order to specifically describe the embodiments so that a person having ordinary knowledge in the art to which the present disclosure pertains may easily implement the present disclosure. Accordingly, it does not mean that the scope of protection of the present disclosure is limited. Accordingly, some components may be substituted or changed without departing from an essential area of the present disclosure.

In the following description, when it is described that one component is “connected to” the other component, the one component may be directly connected to the other component or may also be connected to the other component through a third component or device therebetween. Furthermore, when it is said that a part “includes” a component, this means that the part may further include another component not the exclusion of another component unless explicitly described to the contrary.

A transmittance-variable liquid crystal film cell according to an implementation example of the present disclosure may mean a complex film including a liquid crystal cell capable of changing the transmittance of electromagnetic waves, such as a visible ray that passes through the transmittance-variable liquid crystal film depending on whether external electric energy is applied thereto. The transmittance-variable liquid crystal film cell may be used solely or by being attached to an optical product.

Accordingly, in this specification, the transmittance-variable liquid crystal film cell is defined to mean a complex film having a thin film form including a liquid crystal cell, which can change the transmittance of electromagnetic waves depending on whether external electric energy is applied thereto, and may be widely expanded and interpreted as including even a complex film to which another functional film is additionally attached.

In particular, the transmittance-variable liquid crystal film cell according to an implementation example of the present disclosure may be a liquid crystal film cell having a thin film form, which may be attached to a curved surface type optical device, and may be effectively applied to an eyewear product group having a curved surface type, which may be worn in various forms, such as a visor for a bike helmet and an eyewear for AR. In this specification, the eyewear product group may refer to a variety of products which may be worn to be close to the eye by being attached to another device, such as a helmet, in addition to eyewears in a narrow sense.

Hereinafter, a transmittance-variable liquid crystal cell in which the quantity of liquid crystals filled therein is adjusted and a method of manufacturing the transmittance-variable liquid crystal cell according to implementation examples of the present disclosure are exemplarily described with reference to the accompanying drawings. The accompanying drawings are intended to merely exemplarily describe the transmittance-variable liquid crystal cell and the liquid crystal film cell according to implementation examples of the present disclosure, and implementation examples of the present disclosure are not limited to only examples according to the accompanying drawings.

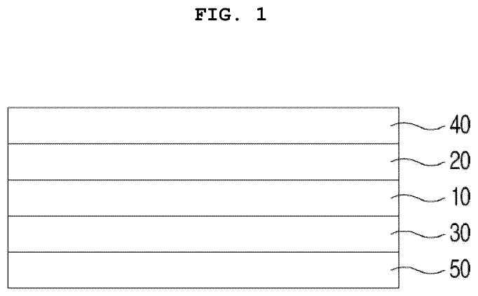

FIG. 1 is a cross-sectional view exemplarily illustrating a basic structure of a transmittance-variable liquid crystal film cell. As illustrated in FIG. 1, the common plane type transmittance-variable liquid crystal film cell may include a liquid crystal cell 10, and a first adhesive layer 20 and a second adhesive layer 30 that correspond to a pair of adhesive layers stacked and disposed on both sides of the liquid crystal cell 10. Furthermore, the common plane type transmittance-variable liquid crystal film cell may further include a first cover layer 40 and a second cover layer 50 that are attached to the first adhesive layer 20 and the second adhesive layer 30, respectively. In this case, the cover layer may be a release film for protecting the adhesive layer against an alien substance, and may be a functional film layer for assigning various functions.

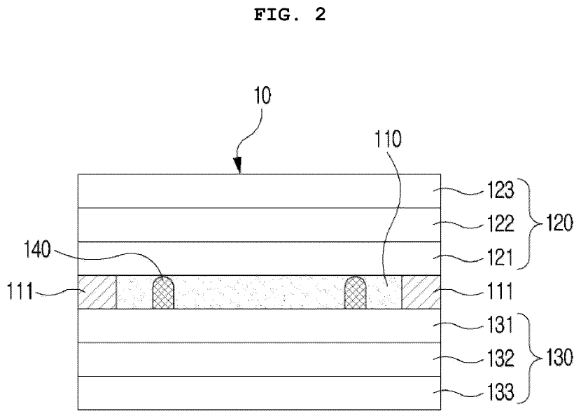

The example of FIG. 1 more simply illustrates an internal stack structure for convenience of description of the transmittance-variable liquid crystal film cell. The liquid crystal cell 10 of FIG. 1 is a cell assembly including a liquid crystal layer that is provided to provide a transmittance-variable function. An example of a detailed construction of the liquid crystal cell 10 is illustrated in FIG. 2. A plane type liquid crystal film cell, such as that illustrated in FIG. 1, may be molded as a transmittance-variable liquid crystal film cell that has been subjected to curved surfacing through a curved surfacing process. The curved-surfaced transmittance-variable liquid crystal film cell is the same as the plane type liquid crystal film cell of FIG. 1 in its basic stack structure except that the curved-surfaced transmittance-variable liquid crystal film cell has a curved surface shape.

For reference, the example of FIG. 2 is provided to describe a basic structure of the liquid crystal cell according to an implementation example of the present disclosure. The liquid crystal cell of FIG. 2 is a plane type liquid crystal cell the transmittance of which may be changed. A plane type liquid crystal cell, such as that illustrated in FIG. 2, may be formed into a transmittance-variable liquid crystal cell that is subjected to curved surfacing through a curved surfacing process. The curved-surfaced transmittance-variable liquid crystal cell is the same as the plane type liquid crystal cell of FIG. 2 in its basic stack structure except that the curved-surfaced transmittance-variable liquid crystal cell has a curved surface shape.

Hereinafter, a basic structure of the transmittance-variable liquid crystal cell is described with reference to FIG. 2.

A liquid crystal cell according to an implementation example of the present disclosure has a stack structure in which the transmittance of the liquid crystal cell may be changed through a switching operation based on an electrical signal that is applied from the outside, and may include a liquid crystal layer including a liquid crystal compound.

In an implementation example of the present disclosure, a liquid crystal cell may be constructed to include a mixture of liquid crystals (host) and a dye (guest) in which the liquid crystals and a dichroic dye have been mixed. The transmittance of the liquid crystal cell may be changed because a change in the arrangement state of a liquid crystal compound and the dichroic dye within the liquid crystal layer is induced based on an externalelectric force, such as a voltage. The liquid crystal cell may mean a stack structure in which the liquid crystal cell may switch to a state in which the liquid crystal cell has different transmissivity depending on whether an externalelectric force, such as a voltage, is applied.

A switchable state mode of the liquid crystal cell may include a transmittance mode and a blocking mode which are determined depending on whether a voltage is applied. In the transmittance mode, the transmissivity of the transmittance-variable liquid crystal film cell including the liquid crystal cell may at least about 20% or more, 25% or more, 30% or more, 35% or more, 40% or more, 45% or more, 50% or more, 55% or more, 60% or more, 65% or more, 70% or more, 75% or more, or 80% or more. Furthermore, in the blocking mode, the transmissivity of the transmittance-variable liquid crystal film cell may be 60% or less, 55% or less, 50% or less, 45% or less, 40% or less, 35% or less, 30% or less, 25% or less, 20% or less, 15% or less, 10% or less, or 5% or less. It is advantageous when the transmissivity is higher in the transmittance mode and when the transmissivity is lower in the blocking mode. An upper limit of the transmissivity in the transmittance mode state and a lower limit of the transmissivity in the blocking mode are not specially limited. In an example, the upper limit of the transmissivity in the transmittance mode may be about 90%, and the lower limit of the transmissivity in the blocking mode may be about 3%.

Furthermore, a state change related to the transmissivity is not limited to alternately providing the two state modes, that is, the transmittance mode and the blocking mode. For example, various state modes may be provided so that the transmissivity can be controlled to a desired level step by step through voltage control. The structure of the liquid crystal cell that is provided to construct the transmittance-variable liquid crystal film cell may adopt an already known structure. In this specification, the basic structure of the liquid crystal cell is described in brief through attached examples.

The liquid crystal cell according to an implementation example of the present disclosure has a sealing space structure having a liquid crystal layer that is disposed within a space formed by two transparent conductive substrate films that are disposed to face each other and an edge sealing part, and may be a cell assembly constructed to change transmittance by changing the orientation state of the liquid crystal compound and the dichroic dye within the liquid crystal cell depending on whether an external voltage is applied to transparent conductive upper and lower substrate films.

Referring to the example of FIG. 2, the liquid crystal cell 10 has a structure in which transparent conductive substrate films have been stacked up and down on the basis of a liquid crystal layer 110 in which liquid crystals including a dichroic dye have beenfilled. The transparent conductive substrate films may be divided into a first substrate 120 at an upper part thereof and a second substrate 130 at a lower part thereof. Furthermore, the transparent conductive substrates, that is, the first substrate 120 and the second substrate 130, have structures in which orientation films 121 and 131, transparent electrode layers 122 and 132, and base layers 123 and 133 have been sequentially stacked, respectively, which may be symmetrically stacked on the basis of the liquid crystal layer 110. For example, the liquid crystal cell may have a structure in which the first electrode layer 122 made of an indium tin oxide (ITO) thin film and the first orientation film 121 having an orientation ability for a liquid crystal compound are formed on the first base layer 123 which may be made of a polyethylene terephthalate (PET) film and the liquid crystal layer 110 is injected thereon. Furthermore, the liquid crystal cell may have a structure in which the second orientation film 131, the second electrode layer 132 made of an indium tin oxide (ITO) thin film, and the second base layer 133 made of a polyethylene terephthalate (PET) film have been symmetrically sequentially stacked on the liquid crystal layer 110 on the basis of the liquid crystal layer 110. A fixed type spacer may be formed between the electrode layer and the orientation film in any one of the first substrate and the second substrate.

A plastic film may be used as the base layer. Detailed examples of the plastic film may include films including triacetyl cellulose (TAC); cyclo olefin copolymer (COP) such as a norbornene derivative; polymethyl methacrylate (PMMA); polycarbonate (PC); polyethylene (PE); polypropylene (PP); polyvinyl alcohol (PVA); diacetyl cellulose (DAC); polyacrylate (PAC); polyether sulfone (PES); polyether ether ketone (PEEK); polyphenylene sulfide (PPS), polyether imide (PEI); polyethylene naphthalate (PEN); polyethylene terephthalate (PET); polyimide (PI); polysulfone (PSF); polyarylate (PAR), or amorphous fluoro resin, but the present disclosure is not limited thereto.

A known transparent electrode layer capable of applying electric energy to the liquid crystal layer so that the orientation state of the liquid crystal layer can be changed may be applied as the electrode layer. A metal oxide layer, such as a conductive polymer layer, a conductive metal layer, a conductive nanowire layer, or an indium tin oxide (ITO), may be used as the transparent electrode layer.

The orientation film is provided to orient the liquid crystal compound, and may have the orientation ability capable of controlling the orientation of the liquid crystal layer. Known materials having the orientation ability for liquid crystal molecules may be used as the orientation film. For example, the orientation film may be made of a material indicative of the orientation ability by rubbing orientation or a material indicative of the orientation ability by light radiation. A polyimide compound, a polyvinyl alcohol compound, a polyamic acid compound, a polystyrene compound, a polyamide compound, and a polyoxyethylene compound may be used as the material indicative of the orientation ability by rubbing orientation. A polyimide compound, a polyamic acid compound, a polynorbornene compound, a phenylmaleimide copolymer compound, a polyvinyl cinnamate compound, a polyazobenzene compound, a polyethylene imine compound, a polyvinyl alcohol compound, a polyamide compound, a polyethylene compound, a polystyrene compound, a polyphenylene phthalamide compound, a polyester compound, a chloromethylated polyimide (CMPI) compound, and a polymethyl methacrylate compound may be used as the material indicative of the orientation ability by light radiation. In addition to the examples, a known material capable of providing the orientation ability may be used as the orientation film.

The liquid crystal layer means a layer including the liquid crystal compound, and may be a guest-host liquid crystal layer including a liquid crystal compound (host) and a dichroic dye (guest), for example.

The liquid crystal compound may be present within the liquid crystal layer so that the orientation direction of the liquid crystal compound is changed depending on whether an external voltage signal is applied thereto. All types of liquid crystal compounds may be used as the liquid crystal compound if the orientation direction of the liquid crystal compound can be changed by applying an external electrical signal to the liquid crystal compound. For example, a smectic liquid crystal compound, a nematic liquid crystal compound, or a cholesteric liquid crystal compound may be used as the liquid crystal compound. Furthermore, the liquid crystal compound may be a compound that does not include a polymerizable group or a bridging group, for example, so that the orientation direction of the liquid crystal compound can be freely changed by applying an external signal thereto.

The dichroic dye is a material the absorption rate of light of which is changed based on a polarized direction, and may mean an organic material capable of intensively absorbing light within at least a part of or the entire range of a visible ray area, for example, a 400 nm to 700 nm wavelength range in order to provide a transmittance-variable characteristic. For example, a black dye may be used as the dichroic dye. For example, an azo compound dye or an anthraquinone dye is known as the dye, but the present disclosure is not limited thereto. According to an implementation example of the present disclosure, for transmittance-variable, a mixture of the liquid crystal compound and the dichroic dye may be used. In this specification, the mixture of the liquid crystal compound and the dichroic dye is called a liquid crystal dye mixture. Furthermore, according to another implementation example of the present disclosure, a liquid crystal cell to which a polarization functional film has been attached or on which polarization function coating has been performed may be used. A mixture of the liquid crystal and the liquid crystal dye included in these examples is collectively called a liquid crystal. Accordingly, in this specification, the liquid crystal may be interpreted as including all of various liquid crystal mixtures including the liquid crystal compound that is included in the liquid crystal cell for transmittance-variable.

Hereinafter, in an implementation example of the present disclosure, the liquid crystal cell that changes its transmittance by using the liquid crystal dye mixture and a vacuum lamination manufacturing method thereof are basically described, but the present disclosure is not limited thereto.

Furthermore, the liquid crystal layer 110 may further include a spacer 140. The spacer 140 is entirely formed and fixed on the ITO layer of the first substrate or the second substrate and has a function for maintaining a gap between the first substrate and the second substrate, that is, a cell gap. The spacer may be provided in the state in which the spacer has been attached on the transparent electrode layer of the first or second substrate.

A column spacer or a ball spacer may be used as the spacer 140. The spacer may include one type or more that is selected from a group consisting of a carbonl-series material, a metal-series material, an oxide-series material, and a complex material of them. In one example, the column spacer may be formed before the orientation film is formed on the transparent electrode film in the first substrate or the second substrate. In one example, the ball spacer may be formed by mixing and coating the ball spacer on the orientation film when the orientation film is coated on the transparent electrode layer of the first substrate or the second substrate. The column spacer may also be formed on the transparent electrode layer of the first substrate or the second substrate by a photolithography method. The width (or diameter) and thickness (or height) of the column spacer and the diameter (height) of the ball spacer may be properly changed depending on the size of a final target product.

Furthermore, in order to define the area of the liquid crystal cell and to bonding the upper and lower transparent conductive substrates of the liquid crystal cell, a sealing part using a curing sealant may be formed near an outskirt edge part of the liquid crystal cell. The sealing part may include a single sealant line or may have a complex sealant line structure including an internal sealant and an external sealant.

According to an implementation example of the present disclosure, the sealant line may be drawn as a dual structure of an inner sealant line and an outer sealant line. The sealant lines may be drawn as sealants having the same material, or may be drawn as sealants having different materials. It is preferred that the width of the inner sealant line is 2 mm or less after the bonding and curing of the sealing part in order to correspond to a fine communication channel structure. The outer sealant line includes an incision line in most of areas except the opening of the communication channel. The outer sealant line plays a role to reinforce adhesive strength between the substrate films.

In contrast, the sealant line may be formed of a single sealant line. In this case, the width of the sealant line may be 2 mm or to 10 mm or less. The sealant line is drawn as a single sealant line or a plurality of sealant lines only from a design aspect. The sealant line may have any form if the main filling area and the bank for liquid crystal injection can be divided into sections by the sealant line and the communication channel and the two areas can be separated by the incision line according to the subject matter of the present disclosure and a related sealant line.

The transmittance-variable liquid crystal cell according to an implementation example of the present disclosure may be a guest (dichroic dye)-host (liquid crystal) liquid crystal cell having visible ray transmittance changed depending on whether an external electric field is applied thereto. As described above, in an implementation example of the present disclosure, the liquid crystal film cell may mean that a functional film has been entirely attached to the liquid crystal cell by using an adhesive. For example, the functional film may include a film having an anti-fog function, a low reflection function, and an anti-reflection function. It is preferred that the thickness of the functional film that is applied in an implementation example of the present disclosure is greater than an average thickness of the first and second substrate films, preferably, a thickness greater than the thickness of the liquid crystal cell. The functional film that is thick may reinforce the cell gap that is widened due to a difference between the lengths of the first and second substrate films when the liquid crystal cell is applied to an: internal base of a curved optical instrument.

The transmittance-variable liquid crystal cell may be manufactured by dispensing the liquid crystal dye mixture between the transparent conductive substrate films and bonding the first and second substrate films under vacuum. The vacuum lamination process according to an implementation example of the present disclosure has an advantage in that productivity is high compared to a vacuum tabulation process of injecting the liquid crystal mixture through an entrance and an exit that have been previously formed.

In this case, the spacer is used to maintain the cell gap of the liquid crystals. In order to trap the liquid crystal dye mixture and to seal the mixture by the substrate films, the sealing part 111 is formed by using the curing sealant in the outskirt part of the liquid crystal cell. After the liquid crystal cell is bonded under vacuum, the sealant is cured by UV and/or heat under an atmospheric pressure condition.

The transmittance-variable liquid crystal cell according to an implementation example of the present disclosure may include a transparent electrode substrate film to which vertically oriented liquid crystals and a vertical orientation film have been applied in order to achieve the highest transmittance in the state in which an electric field has not been applied. In an implementation example of the present disclosure, liquid crystals that are vertically oriented when a voltage is not applied thereto are called vertically oriented liquid crystals. Light transmittance is the highest when a voltage is not applied, which is called a normally clear mode.

However, the problem of agglomeration of liquid crystal dye mixture and bubble generation during long-term use is not limited to vertically oriented liquid crystals, that is, the normally clear mode. Bubbles may be generated even in the horizontally oriented liquid crystals, that is, a normally black mode in the long term, and the agglomeration of liquid crystals may be observed when voltage is applied.

The vertically oriented liquid crystal cell may be suitable for an eyewear for sports, an eyewear for a driver, an eyewear for a bike helmet visor, and a transmittance-variable eyewear for AR. Such eyewears are usually used in the state in which transmittance is high in the state in which a voltage has not been applied. Furthermore, most of optical device bases have a curved surface type. The transmittance-variable liquid crystal cell is basically applied to an inner curved surface of the curved surface base. In this case, the term “applied” means full attachment, partial attachment, and mechanical fixing. Accordingly, the transmittance-variable liquid crystal cell in which the quantity of liquid crystals filled therein is adjusted according to an implementation example of the present disclosure is suitable for a thin film type liquid crystal cell that is applied to the curved surface of the base of a curved surface type optical device, and is suitable for eyewears composed of the vertically oriented liquid crystal cell, in particular.

When the liquid crystal cell manufactured in the plane state is applied to the curved surface base, the cell gap between the first and second substrate films is reduced as the plane state is subjected to curved surfacing, and the liquid crystals and the dichroic dye at a corresponding part are moved to a portion having a relatively large curvature radius. Accordingly, in the case of the vertically oriented liquid crystal cell, a liquid crystal dye agglomeration stain having a dark color may occur. When the liquid crystal dye mixture is moved and gathered, the cell gap is increased. When the cell gap is greater than the twist pitch of liquid crystals, the vertical orientation characteristic of the liquid crystal dye mixture is deteriorated, and the liquid crystal dye agglomeration stain having a dark color appears in the state in which a voltage has not been applied. In particular, as the filling rate of the liquid crystal dye mixture within the liquid crystal cell is greater than about 102%, the liquid crystal dye agglomeration stain having a dark color may be found more easily. If the quantity of liquid crystals filled as described above is excessive, the size of the agglomeration is increased and a dark color appears.

In contrast, if the filling rate of the liquid crystal dye mixture is reduced within 100%, the agglomeration stain is very small or does not occur. However, the possibility that bubbles are generated in the long term is increased due to a difference in air pressure between the inside and outside of the liquid crystal cell. The reason for this is that the filling rate of liquid crystals within the liquid crystal cell is insufficient. If an individual liquid crystal cell that has been bonded under vacuum is taken out to atmospheric pressure after sealed in the vacuum state in the state in which the quantity of liquid crystals that fill the space of the liquid crystal cell is insufficient, the substrate films were deformed into a bonded state due to the pressure difference between inside and outside of the liquid crystal cell, causing the internal space to shrink. From an external appearance of the liquid crystal cell with the shrinking internal space, the liquid crystal dye mixture appears to be well filled without an empty place when viewed in the plane state. However, as the liquid crystal cell is used under various environments in the long term, bubbles are generated because outside air penetrates into the liquid crystal cell.

As described above, the filling rate of the liquid crystal dye mixture within the liquid crystal cell may have a direct influence on internal bubbles or the occurrence of the agglomeration of liquid crystals. Accordingly, it is necessary to approximately optimize the filling rate to 100% and to remove a pressure difference between the inside and outside of the liquid crystal cell so that a liquid crystal dye agglomeration stain attributable to the distortion and contraction of the internal space is not present when curved surfacing is applied and bubbles are not generated in the long term.

In relation to control of the filling rate of the liquid crystal dye mixture within the liquid crystal cell, a common internal filling process of a transmittance-variable liquid crystal cell that is manufactured through a vacuum lamination process is described in brief. First, a process of forming a sealing part on a substrate film to which a spacer has been fixed in the outskirt area of a liquid crystal cell by a sealant line having a closed curve shape by using an uncured sealant is performed. Thereafter, a mixture of a liquid crystal compound and a dichroic dye having a preset quantity is dispensed within the closed curve of the sealant line of the sealing part. A plane type liquid crystal cell is manufactured by bonding the substrate films in the vacuum state.

In this case, the filling rate (%) of the liquid crystal dye mixture within the liquid crystal cell is determined by the volume of the internal space of the liquid crystal cell (an inner area of the closed curve of the sealant line x an average height of the spacer) and the filling quantity (or filling volume) of the liquid crystal dye mixture. For example, when the volume of the internal space of the liquid crystal cell and the filling volume of the liquid crystal dye mixture are identical with each other, the filling rate of the liquid crystal dye mixture is 100%.

If the generation of bubbles is not present in the long term, the filling rate may be 100% or more. Such a case is a condition in which the upper and lower substrate films are not deformed due to a pressure difference after vacuum lamination because the pressure difference between the inside and outside of the liquid crystal cell disappears.

However, an error may occur compared to the volume of an actual space when the volume of the internal space is calculated due to the deformation of the flexible upper and lower substrate films, the height of the sealant line part, which is higher than the height of the spacer in general, and a deviation of the height of the spacer. Furthermore, there is also an error that occurs when the liquid crystal dye mixture is dispensed with a required quantity. Accordingly, it is not easy to manufacture a liquid crystal cell having a filling rate of accurately 100% due to the above errors. As a result, it is also not easy to predict an actual filling rate of the liquid crystal cell that is used in an atmospheric pressure environment after the liquid crystal cell is bonded under vacuum and whether bubbles are generated in the future.

In order to reduce the possibility that bubbles are generated, a scheme for manufacturing a liquid crystal cell having a sufficient filling rate, for example, a liquid crystal cell having a filling rate of 102% or more may be considered. In this case, a black stain may locally occur in the liquid crystal dye mixture because a local liquid crystal cell gap is greater than an average height of the spacer due to the filling quantity of excessive liquid crystals. The black stain is a black stain that appears as an amorphous stain over the entire area of a liquid crystal cell if an excessive quantity of liquid crystals is filled into the liquid crystal cell, and is different from an agglomeration stain attributable to a movement of a liquid crystal dye, that is, the results of curved surfacing.

A phenomenon in which a liquid crystal dye is agglomerated may occur because the liquid crystal dye mixture moves from an area having a small curvature radius to an area having a large curvature radius when a liquid crystal cell with which liquid crystals have been excessively filled is applied to an inner base of a curved surface type optical device and thus a pressure difference occurs in the liquid crystal dye mixture. The phenomenon in which the liquid crystal dye is agglomerated occurs because he liquid crystal dye mixture moves to an edge part of the liquid crystal cell in a longitudinal axis direction thereof as a liquid crystal cell gap at the central part of the liquid crystal cell in the longitudinal axis direction is reduced in a process of performing curved surfacing on the plane type liquid crystal cell.

Another cause of the phenomenon in which the liquid crystal dye is agglomerated may occur because a difference between the lengths of substrate films that constitute a liquid crystal cell occurs when a plane type liquid crystal cell is applied to the inside of the curved surface of an optical device. A liquid crystal cell gap of an edge part is widened due to the difference between the lengths of the substrate films, and the liquid crystal dye mixture gathers at the widened part.

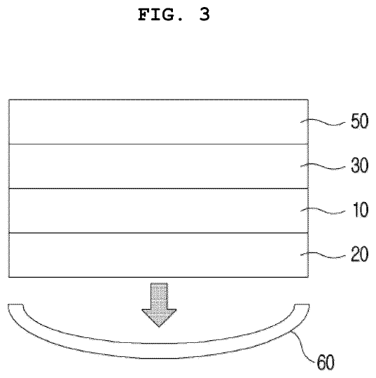

FIG. 3 illustrates a bonding process of applying a plane type transmittance-variable liquid crystal cell to the curved surface of the inside of an optical device having the curved surface. In this case, the term “applying” means terms, including fullattachment, partial attachment, and mechanical fixing.

As illustrated in FIG. 3, in a conventional plane type transmittance-variable liquid crystal film cell having a flat film form, a method of manufacturing a curved surface type optical product by closely integrally attaching the plane type transmittance-variable liquid crystal film cell to a curved surface type optical part, such as an optical lens.

In this case, before a bonding process, such as that illustrated in FIG. 3, is performed, the transmittance-variable liquid crystal film cell may be previously cut in a form necessary for the optical product. In addition, an additional functional film layer is laminated on the liquid crystal film cell, the liquid crystal film cell on which the functional film layer is laminated can be used in a bonding process with a curved optical component.

For example, a curved surface type transmittance-variable optical device may be manufactured by first preparing a transmittance-variable film cell having a stack structure, such as that illustrated in FIG. 1, removing the first cover layer 40 corresponding to a first release film layer on the outermost side of the prepared transmittance-variable film cell, and applying the first adhesive layer 20 of the transmittance-variable film cell that is exposed as the first release film layer is removed to an internal curved surface of a curved surface type lens 60.

As another example, a curved surface type transmittance-variable optical device may be manufactured in a way to form an adhesive layer on one side of a transmittance-variable liquid crystal cell, such as that illustrated in FIG. 2, and applying the adhesive layer to the internal curved surface of the curved surface type lens 60.

As described above, in a conventional technology, in general, a curved surface type transmittance-variable optical device is manufactured by manufacturing a plane type transmittance-variable liquid crystal cell, such as that illustrated in FIG. 2, manufacturing a transmittance-variable film cell including an adhesive layer by using the adhesive layer, and then applying the plane type transmittance-variable liquid crystal cell to the curved surface base of the curved surface type optical device through the medium of the adhesive layer as illustrated in FIG. 3.

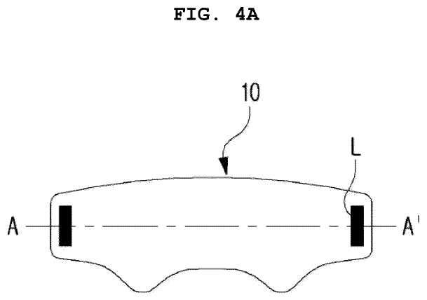

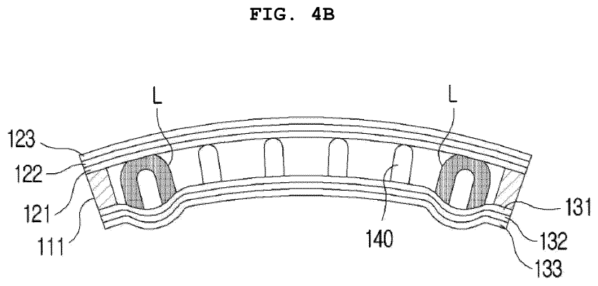

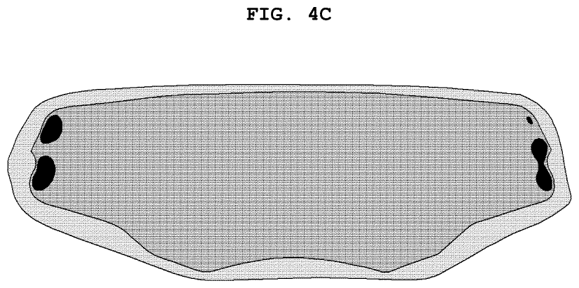

Meanwhile, in the case of the manufacturing process as above, the occurrence of the agglomeration of liquid crystals within the liquid crystal cell of the transmittance-variable film cell has been continuously observed. FIGS. 4A to 4C illustrate examples in which the agglomeration of liquid crystals occurs in a conventional transmittance-variable liquid crystal cell.

FIG. 4A is a plan view of the transmittance-variable liquid crystal cell in which the agglomeration of liquid crystals occurred. FIG. 4B illustrates a cross section taken along line A-A′ in FIG. 4A. FIG. 4C is an example of the transmittance-variable guest-host liquid crystal cell in which the agglomeration of liquid crystals and the dichroic dye actually occurred.

FIG. 4A illustrates an example in which the agglomeration L of liquid crystals occurs at edge parts of the transmittance-variable liquid crystal cell on both sides thereof. Referring to the cross section of FIG. 4B, a cell gap is increased at the edge parts of the liquid crystal cell on both sides thereof due to a movement of liquid crystals and the occurrence of a pressure difference. The agglomeration L of the liquid crystals occurs due to an increase of the cell gap. The agglomeration of the liquid crystals occurs because the orientation state of liquid crystals is changed due to the widening of the cell gap unlike a normal part. If a dichroic dye is included, the transmittance of a liquid crystal agglomeration part is quite different from the normal part.

FIG. 4C illustrates an example in which the agglomeration of liquid crystals occurred in an actual liquid crystal cell. In FIG. 4C, in the case of a vertically oriented (normally clear) guest-host liquid crystal cell in which a dichroic dye forms a liquid crystal layer along with liquid crystals, the orientation of the dichroic dye is broken and thus a black color appears in an area in which the agglomeration of liquid crystals occurs due to an increase of the cell gap because the dichroic dye has the same orientation as the liquid crystals.

In order to solve problems of a liquid crystal dye agglomeration stain and the generation of bubbles in the long term upon such curved surfacing, in an implementation example of the present disclosure, the structure of the sealant line having a closed curve shape, including the bank for liquid crystal injection and the main filling area, is formed on the lower substrate film prior to vacuum lamination. The sealant line is an outskirt edge for partitioning the internal space of the plane type liquid crystal cell with which liquid crystals may be filled, and may have a closed shape form so that the liquid crystals dispensed within the internal space do not leak. In particular, in forming a closed sealing area that surrounds the internal space of the plane type liquid crystal cell with which the liquid crystals are filled, the sealant line having a closed curve shape may be constructed to partition the internal space of the sealing part into the main filling area and the bank for liquid crystal injection and the two areas may be connected by the communication channel. Accordingly, the sealant line may be integrally drawn on the lower substrate film so that the main filling area, the bank for liquid crystal injection, and the communication channel for connecting the main filling area and the bank for liquid crystal injection can be formed. After the liquid crystal dye mixture is dispensed with a predetermined quantity, an outskirt sealing area may be formed by bonding the upper and lower substrate films in the vacuum state.

In an actual manufacturing process, several liquid crystal cells may be simultaneously manufactured by disposing the several liquid crystal cells on the original plate of a substrate film, which is greater than an individual liquid crystal cell, without laminating the individual liquid crystal cells that are cut in a desired shape under vacuum, laminating the original plates of the upper and lower substrate films under vacuum, and cutting the sealing part in the atmospheric pressure state.

According to an implementation example of the present disclosure, the incision line for cutting the individual liquid crystal cell in a required shape may be constructed to open at least a part of the sealing part area. Preferably, the incision line may be cut so that at least a part of the communication channel is exposed to the outside after transecting a part of the communication channel. In this case, the meaning that the incision line transects a part of the communication channel may include that at least a part of the communication channel is exposed as at least a part of the communication channel in the sealing part area that forms the closed curve is cut by the incision line. Furthermore, the exposure of at least a part of the communication channel means that a channel through which liquid crystals may pass on the inside of the sealant line is exposed to the outside that neighbors the air. In this case, the exposed channel may be exposed in the state in which the channel has been closed by a finishing sealant after the cutting or has been previously closed by the finishing sealant prior to the cutting.

In particular, according to an implementation example of the present disclosure, cutting the sealing part for the incision line is for merely cutting the transmittance-variable liquid crystal cell in a required shape, and is not for exposing the communication channel. After the communication channel is first closed by the finishing sealant, the sealing part may be cut in the state in which a movement of the liquid crystal dye mixture has been blocked, or the finishing sealant may be injected into the exposed opening of the communication channel after the sealing part is cut so that the communication channel is exposed.

The internal space of the sealing part is divided into the main filling area and the bank for liquid crystal injection on the basis of the incision line and the communication channel. The bank for liquid crystal injection functions as an assistant area for filling an insufficient quantity of liquid crystals of the main filling area. Accordingly, the bank for liquid crystal injection may be removed through a cutting process after the filling quantity of the liquid crystals is adjusted.

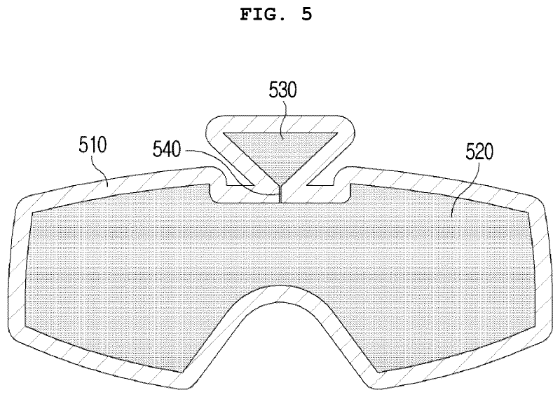

Accordingly, the original plate of the transmittance-variable liquid crystal cell including the internal space of the sealing part having a closed curve shape including the main filling area and the bank for liquid crystal injection may have an intermediate product form before the final product cut in a required shape is manufactured. Such a structure is illustrated in FIG. 5.

Specifically, FIG. 5 illustrates an example of a transmittance-variable liquid crystal cell in which the quantity of liquid crystals filled therein is adjusted, which includes the bank for liquid crystal injection that communicates with the main filling area according to an implementation example of the present disclosure. As illustrated in FIG. 5, according to an implementation example of the present disclosure, the internal space of the sealing part to which the liquid crystal dye mixture is dispensed is partitioned by the sealant line. The internal space of the sealing part includes the main filling area and the bank for liquid crystal injection, which communicates with the main filling area, prior to cutting.

For reference, according to a preferred example of the present disclosure, the sealant line may be drawn to have a dual structure of the inner sealant line and the outer sealant line.

In subsequent drawings, only one sealant line is indicated. Furthermore, the same spacer as the inside of the liquid crystal cell may be distributed in the same way even in the line width of the sealant line.

The example of FIG. 5 illustrates the liquid crystal cell in the state in which the liquid crystal dye mixture has been dispensed to the sealant line 510 between the first substrate film corresponding to the upper substrate and the second substrate film corresponding to the lower substrate. In particular, FIG. 5 illustrates an example including one individual liquid crystal cell, but the original plate of the liquid crystal cell may have a plurality of two or more individual liquid crystal cells connected.

Furthermore, FIG. 5 illustrates an example in which the bank 530 for liquid crystal injection has been formed only at the end of the sealant line 510 on one side thereof, but the bank 530 for liquid crystal injection may include two or more areas that are divided from each other. In such an example, the communication channel 540 that is connected to the bank 530 for liquid crystal injection also needs to be constructed in a plural number.

As illustrated in FIG. 5, the internal space of the sealing part that is partitioned by the sealant line 510 is divided into the main filling area 520 and the bank 530 for liquid crystal injection, which communicates with the main filling area 520. The bank 530 for liquid crystal injection may be connected to the main filling area 520 through the communication channel 540.

The main filling area 520 means a valid liquid crystal cell area that is attached to an optical base and that performs transmittance-variable performance, and is a portion that resides on a final individual product although the sealant line 510 having a closed curve shape is cut by the incision line CL.

In contrast, the bank 530 for liquid crystal injection is a portion that is integrally connected to the main filling area 520 through the communication channel 540 in the state prior to cutting and forms the internal space of the sealing part by the sealant line 510 along with the main filling area 520, but is removed from the individual transmittance-variable liquid product after the cutting. Furthermore, a crystal cell predetermined part of the bank 530 for liquid crystal injection may be cut and opened so that the predetermined part is exposed to atmospheric pressure. When the predetermined part is exposed to atmospheric pressure, the bank 530 for liquid crystal injection is constructed so that the liquid crystal dye mixture is additionally injected into the main filling area 520.

A part of the bank 530 for liquid crystal injection may form an opening by a method, such as cutting, and may be exposed to atmospheric pressure through the opening of the bank 530 for liquid crystal injection. The opening may be an incised line that is formed by the incision line, for example. Furthermore, according to a preferred embodiment of the present disclosure, the opening may be a line that is lengthily incised to be generally parallel on the lower side of a triangle near the large side of the apex of the bank 530 for liquid crystal injection shape having the triangle, that is, around the lower side of the triangle on a side opposite to the apex disposed at the end of the communication channel 540 on one side thereof, in the state in which the communication channel 540 has been disposed at the apex. As described above, only the liquid crystal dye mixture may be injected into the main filling area 520 through the communication channel 540 by the incised line that is formed around the large side of the apex on the side of the communication channel 540 without the penetration of bubbles. As described above, the opening structure having an incised line shape around the lower side of the triangle is merely one example. A structure may be applied to the opening without being limited if the opening has the structure in which liquid crystals within the bank 530 for liquid crystal injection can be injected into the main filling area 520 due to a pressure difference from atmospheric pressure as the internal space of the bank 530 for liquid crystal injection is exposed to the atmospheric pressure.

The bank 530 for liquid crystal injection, which is exposed to atmospheric pressure through the opening, controls a movement of liquid crystals while operating in conjunction with the atmospheric pressure, and may move the liquid crystals in a direction in which pressure equilibrium is performed. In this case, according to an implementation example of the present disclosure, pressure within the internal space of the sealing part to which the liquid crystals have been dispensed in the vacuum state is relatively lower than the atmospheric pressure when the filling rate of the liquid crystals is 100% or less. Accordingly, when the bank 530 for liquid crystal injection is exposed to the atmospheric pressure, the liquid crystals are additionally injected into the main filling area 520 through the communication channel 540. The filling quantity of the liquid crystals within the main filling area 520 is gradually increased and may converge on an optical filling rate (%), preferably, a value approximate to 100%.

In controlling the filling quantity of the liquid crystals within the main filling area 520 to an optimal filling quantity, the main filling area 520 can be passively filled with liquid crystals by atmospheric pressure without any further filling quantity control. In this case, the filling rate of the internal space of the sealing part may be set less than 100%. For example, an initial filling rate of the liquid crystal dye mixture can be easily managed in a wide margin range of 3% based on a preset initial filling reference value (e.g., 97%). In such an example, a predetermined injection time may be previously set from the time when the opening is cut from the bank 530 for liquid crystal injection, and the communication channel 540 may be closed after the injection time.

Furthermore, according to another implementation example of the present disclosure, in relation to control of the optimal filling quantity of the main filling area 520, the initial filling rate of the internal space of the sealing part may be previously determined by considering the volume of the main filling area 520 and the bank 530 for liquid crystal injection. The initial filling rate may be determined as a filling rate of less than 100%. As a relative volume ratio of the bank 530 for liquid crystal injection to the main filling area 520 is increased, a filling rate margin (i.e., 100−the initial filling rate) is increased because the setting value of the initial filling rate is reduced. When the filling rate margin is increased, there is an advantage in that process easiness is improved, but there is a disadvantage in that the time taken for pressure within the main filling area 520 to reach atmospheric pressure after the bank 530 for liquid crystal injection is opened to the atmospheric pressure is increased. Accordingly, the initial filling rate (%) of the internal space of the sealing part may be preferably in the range of 98% to 96%.

Furthermore, the communication channel 540 is a channel that connects the main filling area 520 and the bank 530 for liquid crystal injection. In particular, the communication channel 540 may function as a supply channel through which the liquid crystal dye mixture of the bank 530 for liquid crystal injection is injected into the main filling area 520. The communication channel 540 may be a channel having a width that is sufficiently smaller than an average width of the bank 530 for liquid crystal injection. As illustrated in FIG. 5, the communication channel 540 may preferably have a structure having a form of a narrow slit that is connected to one apex cross section of the triangle of the bank 530 for liquid crystal injection. However, the example of FIG. 5 is merely one example, and may be a slit that is connected to one side of a cross-section structure of another polygon, such as a quadrangle or a pentagon, or may have a slit structure that is connected to one side cross section of another curved surface form.

The filling rate of liquid crystals of the internal space of the sealing part, which is formed by the sealant line 510 having a closed curve shape, needs to be less than 100% on the basis of the volume of the internal space of the sealing part. In an initial lamination process, a small amount of the liquid crystal dye mixture compared to the volume of a total internal space of the sealant line is present because the liquid crystal dye mixture is dispensed with the filling quantity of less than 100% as described above. The filling rate of the total internal space of the sealing part, including the main filling area 520 and the bank 530 for liquid crystal injection, is less than 100%. In contrast, if it is assumed that the liquid crystal dye mixture are initially dispensed only into the main filling area 520, an initial filling rate of a total liquid crystal dye mixture for the main filling area 520 is greater than 100%. In this case, the total filling rate of the liquid crystal dye mixture for the main filling area 520 means a filling quantity (or a total filling volume) of the total liquid crystal dye mixture for the volume of the main filling area 520. Furthermore, the total filling volume means the volume of a total liquid crystal dye mixture that is filled into a total internal space of the sealant line, which includes the main filling area 520, the communication channel 540, and the bank 530 for liquid crystal injection. Only when the total filling rate of the liquid crystal dye mixture for the main filling area 520 is greater than 100%, after liquid crystals are uniformly spread into the entire internal space of the sealing part, the bank 530 for liquid crystal injection is opened to atmospheric pressure, and the liquid crystals are injected into the main filling area 520 again through the communication channel 540. Accordingly, the main filling area 520 can be additionally filled with the liquid crystals so that the filling rate of the main filling area 520 approximately converges on 100%.

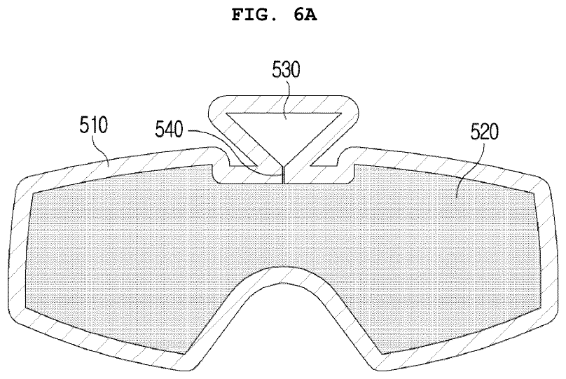

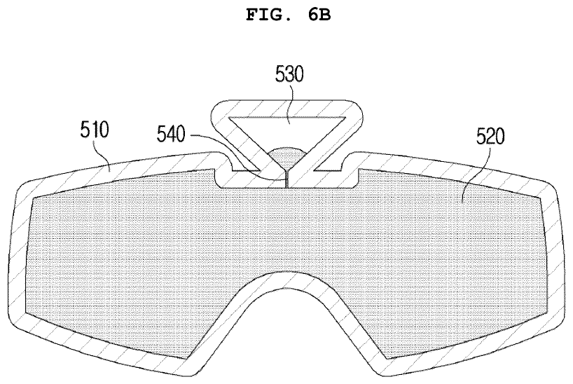

FIGS. 6A and 6B illustrate a process of liquid crystals being sequentially injected into the entire area after vacuum lamination. As illustrated in FIG. 6A, in an initial lamination process of injecting the liquid crystal dye mixture into the entire area by vacuum lamination, liquid crystals are dispensed to the main filling area 520. Thereafter, as illustrated in FIG. 6B, the liquid crystal dye mixture that has been dispensed to the main filling area 520 slowly fills the bank 530 for liquid crystal injection. In the state in which the liquid crystals have been initially dispensed, such as that illustrated in FIG. 6A, the bank 530 for liquid crystal injection has not been filled with the liquid crystals (i.e., vacuum void) at the early stage of vacuum lamination because the liquid crystals are dispensed to only the main filling area 520 (i.e., an actual liquid crystal cell area). Thereafter, as time passes, excessive liquid crystals are moved toward the vacuum void over time (FIG. 6B). As a result, as illustrated in FIG. 5, the liquid crystals are evenly distributed not only in the main filling area 520 but also in the bank 530 for liquid crystal injection.

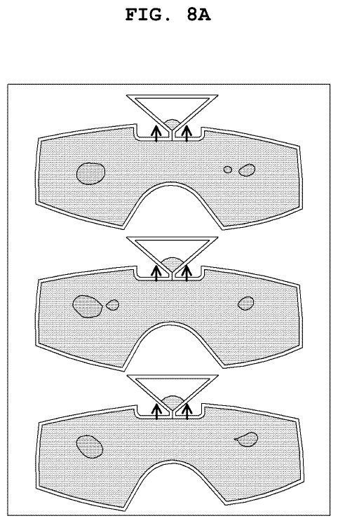

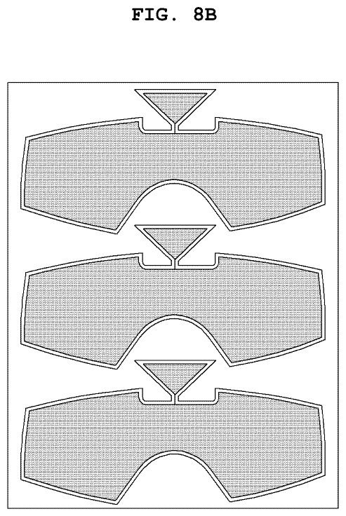

FIGS. 8A and 8B illustrate a process of liquid crystals being filled from the main filling area 520 to the bank 530 for liquid crystal injection within the liquid crystal cell that has been bonded under vacuum, in stages. FIG. 8A corresponds to FIG. 6B and illustrates the state in which liquid crystals are moved toward the bank 530 for liquid crystal injection (i.e., the liquid crystals are moved in an arrow direction in FIG. 8B). FIG. 8B illustrates the state in which the movement of the liquid crystals has been completed and the entire area of the bank 530 for liquid crystal injection has been filled with the liquid crystals as illustrated in FIG. 5.

As described above, on the basis of a filling quantity of the liquid crystal dye mixture that is injected when liquid crystals are initially dispensed (total filling volume), a key is to adjust the filling quantity of the liquid crystal dye mixture so that a first liquid crystal filling rate, which means a total filling volume for the main filling area 520, is greater than 100%, and a second liquid crystal filling rate, which means a total filling volume for the entire area including the bank 530 for liquid crystal injection is less than 100%. Accordingly, as a pressure difference occurs by opening the end of the bank 530 for liquid crystal injection on one side thereof and excessive liquid crystals within the bank 530 for liquid crystal injection are moved to the main filling area 520 again, the filling rate of the liquid crystals within the main filling area (i.e., a substantial liquid crystal cell area) may be controlled to converge on 100%.

When liquid crystals are injected by a common vacuum lamination process, there is a technical difficulty in that it is difficult to secure a desired filling rate of liquid crystals, for example, a filling rate of liquid crystals of 100% for the main filling area 520 due to an error in a process of calculating the volume of the internal space of the liquid crystal cell and an error which may occur in a process of accurately dispensing the quantity of liquid crystals in a calculated internal volume. According to an implementation example of the present disclosure, a filling rate of liquid crystals for the main filling area 520 can be secured at a 100% level by controlling an initial filling volume of the liquid crystals as described above.

A process of the liquid crystals being fully spread into the bank 530 for liquid crystal injection may be performed in a room temperature or high temperature state. For example, the state in which the entire area including the bank 530 for liquid crystal injection has been filled with the liquid crystals can be obtained by leaving the liquid crystal cell along at room temperature about six hours after vacuum lamination or leaving the liquid crystal cell alone at 105° C. about one hour after vacuum lamination. The time depends on the width of the communication channel 540. In relation to the temperature condition, the time that is taken for the liquid crystals to fill the bank 530 for liquid crystal injection may be shorter at the high temperature than at the room temperature.

After the filling process of the liquid crystals for the entire area including the main filling area 520 and the bank 530 for liquid crystal injection is completed, the opening is formed in the bank 530 for liquid crystal injection, and a process of exposing the internal space to atmospheric pressure is performed. When one side of the bank 530 for liquid crystal injection is exposed to the atmospheric pressure through the opening, liquid crystals are injected into the main filling area 520 again due to a pressure difference. After a predetermined time elapses, the re-injection of the liquid crystals may be naturally completed.

Furthermore, according to an implementation example of the present disclosure, the communication channel 540 between the bank 530 for liquid crystal injection and the main filling area 520 may be closed by the finishing sealant S. The finishing sealant S may be a liquid phase sealant. After the liquid phase sealant is injected into the bank 530 for liquid crystal injection, the communication channel 540 may be sealed by the liquid phase sealant that has flown into the communication channel 540. For example, after the opening is formed in the bank 530 for liquid crystal injection, when the re-injection of the liquid crystals is fully completed after a lapse of a predetermined time, the sealing area may be fully closed by injecting the finishing sealant S to the communication channel 540. Furthermore, if the re-injection of the liquid crystals has been sufficiently performed at a required level even before the re-injection of the liquid crystals is fully terminated, for example, if the re-injection speed of the liquid crystals has been sufficiently reduced, sealing may be performed by a liquid phase sealant by injecting the liquid phase sealant to the bank 530 for liquid crystal injection before the inside of the liquid crystal cell reaches atmospheric pressure even in the state in which the liquid crystals have been injected into the main filling area 520.

The communication channel 540, which serves as the sole passage between the main filling area 520 and the bank 530 for liquid crystal injection, is closed through the finishing sealant S. Bubbles can be prevented from being collected between the liquid crystals within the liquid crystal cell and the sealing area because such a closing process can be consecutively performed along with the re-injection process of the liquid crystals. The liquid phase sealant may be cured by a method, such as UV curing or heat curing. The cured sealant fully closes the communication channel 540 of the main filling area 520 through the finishing sealant S.

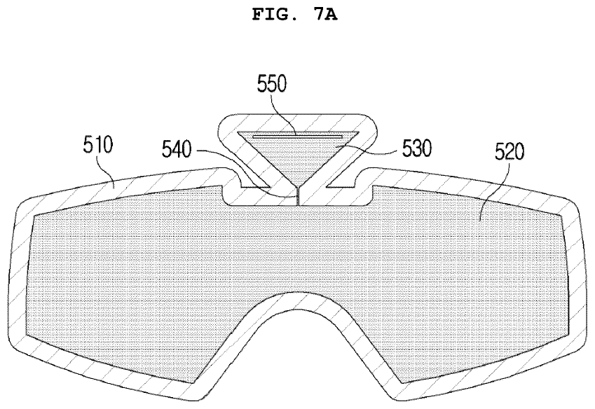

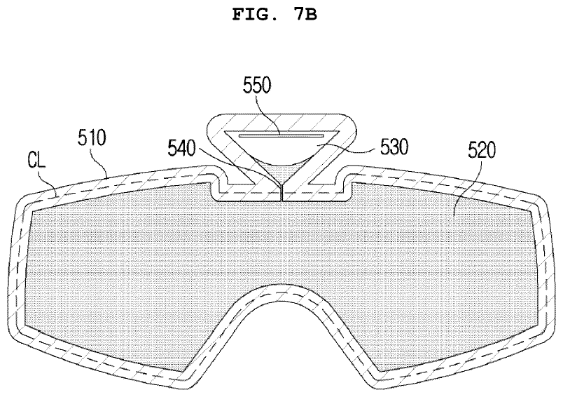

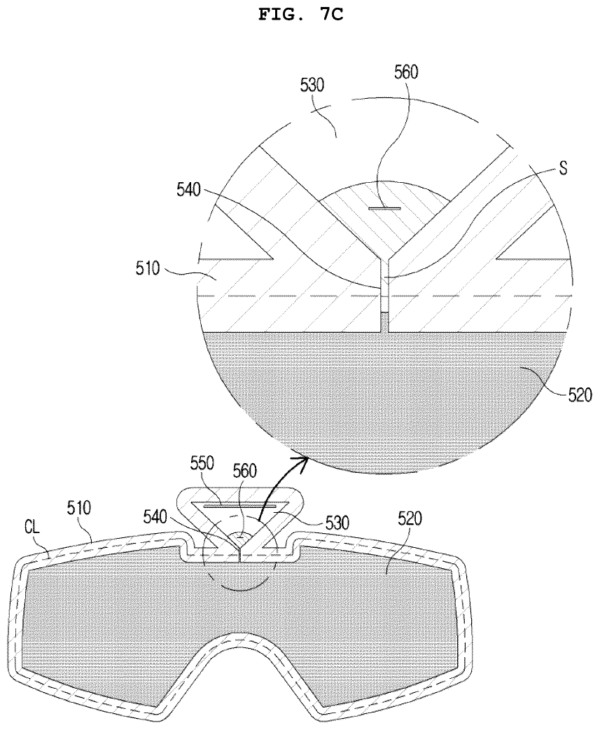

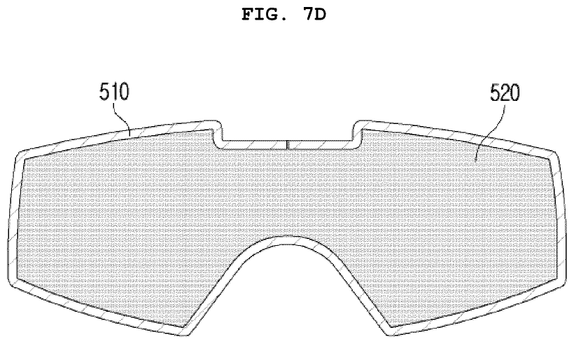

In the transmittance-variable liquid crystal cell in which the quantity of liquid crystals filled therein is adjusted according to an implementation example of the present disclosure, a series of processes of adjusting the filling quantity of liquid crystals are illustrated in FIGS. 7A to 7D.

FIGS. 7A to 7D illustrate enlarged parts of the transmittance-variable liquid crystal cell in which the quantity of liquid crystals filled therein is adjusted in FIG. 5 according to an implementation example of the present disclosure. FIG. 7A illustrates the state in which an opening has been formed on one side of the bank 530 for liquid crystal injection. FIG. 7B illustrates the state in which some of liquid crystals within the bank 530 for liquid crystal injection have moved to the main filling area 520 through the communication channel 540. FIG. 7C illustrates the state in which a second opening 560 has been formed on the other side of the bank 530 for liquid crystal injection and the liquid phase sealant has been injected. FIG. 7D illustrates the state where the sealant line is cut to expose an opening of the communication channel 540 and the exposed opening of the communication channel 540 has been closed by the finishing sealant S.

FIG. 7A illustrates the state in which the opening 550 composed of an incised line has been formed by cutting one side of the bank 530 for liquid crystal injection in the transmittance-variable liquid crystal cell prepared as illustrated in FIG. 5. As described above, the opening 550 is provided to expose the internal space of the liquid crystal cell to atmospheric pressure, and to provide a pressure gradient that enables some of liquid crystals filled into the bank 530 for liquid crystal injection to move to the main filling area 520 in a process of pressure within the internal space of the liquid crystal cell being in equilibrium with the atmospheric pressure.

When the internal space of the liquid crystal cell is exposed to the atmospheric pressure by the opening 550, as illustrated in FIG. 7B, some of the liquid crystals filled into the bank 530 for liquid crystal injection are moved to the main filling area 520 through the communication channel 540 by the atmospheric pressure. As the liquid crystals are moved, some area of the bank 530 for liquid crystal injection, which has been exposed to the atmosphere, is emptied as illustrated in FIG. 7B.

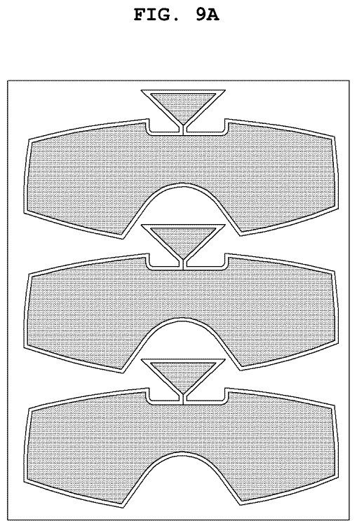

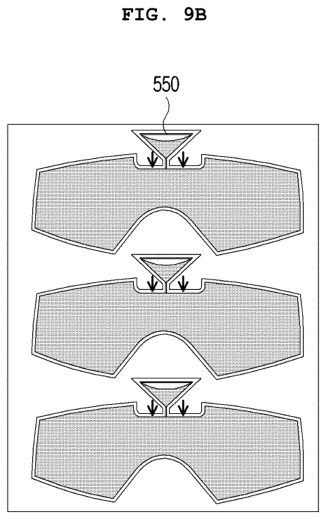

FIG. 9A and FIG. 9B illustrate that liquid crystals were moved to the main filling area 520 due to a pressure difference when the opening 550 was formed on one side of the bank 530 for liquid crystal injection. FIG. 9A illustrates the state in which the liquid crystals were uniformly spread into the entire area within the sealant line including the bank 530 for liquid crystal injection as illustrated in FIG. 8B. FIG. 9B illustrates the state in which the liquid crystals were moving toward the main filling area 520 through the communication channel 540 due to a pressure gradient (i.e., the liquid crystals were moving in an arrow direction in FIG. 9B).

When the liquid crystals are injected into the main filling area 520 again through the communication channel 540 and the filling rate of the main filling area 520 reaches a required level, a process of closing the communication channel 540 by the finishing sealant S and separating and removing the bank 530 for liquid crystal injection may be performed.

In such a process, at least a part of the communication channel 540 may be exposed as a part of the communication channel 540 is cut by the incision line CL. The exposed part of the communication channel 540 may be closed by the finishing sealant S.

The process of closing the communication channel 540 by the finishing sealant S may be performed consecutively to the re-injection process of the liquid crystals before a separate cutting process of cutting across the communication channel 540. In such an example, in the state in which the re-injection of the liquid crystals has been substantially completed, that is, in the state in which the liquid crystals has flown into the main filling area 520 due to a pressure difference and the pressure equilibrium has been achieved, the leakage of the liquid crystals can be prevented and airtightness can be improved by forming a separate opening 560 near the communication channel 540 of the bank 530 for liquid crystal injection, additionally injecting the liquid phase sealant into the communication channel 540 through the opening 560 to close the communication channel 540 (FIG. 7C).

The liquid phase sealant may be injected through the opening 550 formed in FIG. 7A. In contrast, the liquid phase sealant may be injected through the separate opening 560 as illustrated in FIG. 7C. In order to distinguish between the opening 550 and the separate opening 560, an opening for exposure to atmospheric pressure may be called a first opening 550, and an opening for injecting the liquid phase sealant may be called a second opening 560. Preferably, the second opening 560 may be disposed to be closer to the communication channel 540 than the first opening 550.

FIG. 7C illustrates an example including the first opening 550 composed of the incision line, which is formed on one side of the triangular bank 530 for liquid crystal injection, that is, near the lower side of the bank 530 for liquid crystal injection that is far from the communication channel 540 and the second opening 560 that is spaced apart from the first opening 550 and that is formed on the other side of the bank 530 for liquid crystal injection, that is, near the apex of the triangle that is close to the communication channel 540. FIG. 7C illustrates an example including the second opening having an incision line form, but the form of the second opening is not limited to such an example and may be another form in which the liquid phase sealant can be injected, for example, another form such as a needle hole.

As in the example of FIG. 7C, if the second opening 560 is disposed to be sufficiently close to the communication channel 540, the liquid phase sealant may be immediately injected into the communication channel 540 in succession to a flow of the liquid crystals. Accordingly, it is possible to prevent bubbles from being trapped bubbles between the liquid crystals and the sealant or the airtightness from being reduced, and the filling rate of the liquid crystals can be optimally maintained.

In the state in which a movement of the liquid crystals by the atmospheric pressure has been terminated and the pressure equilibrium has been achieved, the liquid phase sealant injected through the second opening 560 may no longer move from the communication channel 540 to the main filling area 520, and resides within the communication channel 540. Referring to FIG. 7C, the second opening 560 was formed in order to inject the liquid phase sealant and the communication channel 540 was closed by injecting the liquid phase sealant through the second opening 560.

Thereafter, the communication channel 540 can be fully closed by curing the liquid phase sealant through UV or heat curing to achieve airtightness. The transmittance-variable liquid crystal cell having a required shape may be manufactured by cutting the sealant line along the incision line CL in preset outskirts thereof.

FIG. 7D illustrates the state in which the opening of the communication channel 540, which has been exposed by cutting the sealant line along the incision line CL as described above, has been fully closed by the finishing sealant S, and illustrates an example of a form of a final product that has been cut along the incision line CL that has been previously formed based on a required product shape.

Meanwhile, even before the injection of the liquid sealant, a method may be applied in which the sealing area is cut along the incision line crossing the communication channel 540 to expose the communication channel 540 to the outside, and then the finishing sealant(S) is directly injected into the opening of the exposed communication channel 540 to close the communication channel 540.

The present disclosure has been described in detail based on the embodiments and the accompanying drawings. However, the scope of the present disclosure is not limited by the embodiments and the accompanying drawings. The scope of the present disclosure will be limited by only the contents described in the claims.

### DESCRIPTION OF REFERENCE NUMERALS

10: liquid crystal cell 20: first adhesive layer
30: second adhesive layer 40: first cover layer
50: second cover layer 60: curved surface type lens
110: liquid crystal layer 111: sealing part
120: first substrate 130: second substrate
140: spacer 121: first orientation layer
131: second orientation layer
122: first electrode layer
132: second electrode layer
123: first base layer 133: second base layer
510: sealant line 520: main filling area
530: bank for liquid crystal injection
540: communication channel 550: first opening
560: second opening
L: agglomeration of liquid crystal dye mixture
CL: incision line S: finishing sealant

1. A transmittance-variable liquid crystal cell in a file type in which liquid crystals have been filled between a first substrate film and a second substrate film,
wherein the liquid crystals form a liquid crystal layer sealed in a vacuum state by being filled in a state in which pressure within an internal space of a sealing part, which is partitioned by a closed sealant line that is formed on the first substrate film or the second substrate film, is lower than atmospheric pressure,
the internal space of the sealing part is divided into a main filling area and a bank for liquid crystal injection, which is connected to the main filling area through a communication channel, and
when one side of the bank for liquid crystal injection of the liquid crystal layer, which has been sealed, is opened by a first opening and exposed to atmospheric pressure, the liquid crystal layer is controlled so that a filling rate of the main filling area is increased as the liquid crystals within the bank for liquid crystal injection flow into the main filling area due to a pressure difference between the pressure within the internal space of the sealing part and atmospheric pressure.

2. The transmittance-variable liquid crystal cell of claim 1, wherein the liquid crystals comprise a liquid crystal dye mixture comprising a dichroic dye.

3. The transmittance-variable liquid crystal cell of claim 1, wherein a film to which a polarization function has been assigned is attached to or a coating layer to which a polarization function has been assigned is formed on a surface of an outside of the liquid crystal cell comprising the first substrate film and the second substrate film.

4. The transmittance-variable liquid crystal cell of claim 1, wherein the liquid crystal layer is formed by dispensing the liquid crystals on an internal area of the sealant line under atmospheric pressure and then bonding the first substrate film and the second substrate film under vacuum.

5. The transmittance-variable liquid crystal cell of claim 1, wherein the liquid crystals filled into the internal space of the sealing part are filled so that a first liquid crystal filling rate meaning a total filling volume of the liquid crystals for a volume of the main filling area in the internal space of the sealing part is greater than 100% and a second liquid crystal filling rate meaning a total filling volume of the liquid crystals for a total volume of the internal space of the sealing part is less than 100%.

6. The transmittance-variable liquid crystal cell of claim 1, wherein the bank for liquid crystal injection has a polygon cross-sectional structure in which an end of the communication channel on one side thereof is an apex.

7. The transmittance-variable liquid crystal cell of claim 6, wherein the bank for liquid crystal injection has a triangular cross-sectional structure formed with one end of the the communication channel as an apex.

8. The transmittance-variable liquid crystal cell of claim 6, wherein the first opening is an incision line that is formed in parallel to a opposite side of the apex of the bank for liquid crystal injection near the communication channel.

9. The transmittance-variable liquid crystal cell of claim 1, further comprising a second opening that is formed in the bank for liquid crystal injection so that the second opening is closer to the communication channel than the first opening and that is opened so that a finishing sealant is injected through the second opening,
wherein the communication channel is closed by the finishing sealant injected through the second opening.

10. The transmittance-variable liquid crystal cell of claim 9, further comprising an incision line that is formed along at least a part of the sealant line and that is formed so that the bank for liquid crystal injection is separated from the main filling area as the incision line transects the communication channel,
wherein an opening of the communication channel that is exposed by cutting the sealant line along the incision line is closed by the finishing sealant.

11. The transmittance-variable liquid crystal cell of claim 1, wherein:
the bank for liquid crystal injection is separated and removed from the main filling area upon cutting by the incision line that transects the communication channel, and
the transmittance-variable liquid crystal cell further comprises a finishing sealant for closing an opening of the communication channel that is exposed upon cutting.

12. A method of manufacturing a transmittance-variable liquid crystal cell, the method comprising:
forming, on a first substrate film or a second substrate film, a closed sealant line that comprises a main filling area and a bank for liquid crystal injection connected to the main filling area through a communication channel under atmospheric pressure;
dispensing liquid crystals on an internal area of the sealant line under the atmospheric pressure and filling the liquid crystals into a liquid crystal cell space by bonding the first substrate film and the second substrate film under vacuum;
forming a first opening on one side of the bank for liquid crystal injection under atmospheric pressure and exposing the bank for liquid crystal injection to the atmospheric pressure through the first opening; and
increasing a filling rate of the main filling area by injecting the liquid crystals within the bank for liquid crystal injection into the main filling area due to a pressure difference between pressure within an internal space of the sealing part and the atmospheric pressure.

13. The method of claim 12, wherein the liquid crystals filled into the internal space of the sealing part are filled so that a first liquid crystal filling rate meaning a total filling volume of the liquid crystals for a volume of the main filling area in the internal space of the sealing part is greater than 100% and a second liquid crystal filling rate meaning a total filling volume of the liquid crystals for a total volume of the internal space of the sealing part is less than 100%.

14. The method of claim 12, wherein the dispensing liquid crystals on an internal area of the sealant line and the filling of the liquid crystals into the liquid crystal cell space comprises:
dispensing the liquid crystals only to the main filling area under the atmospheric pressure,
bonding the first substrate film and the second substrate film under vacuum, and
moving the liquid crystals within the main filling area to the bank for liquid crystal injection at a preset temperature for a preset time under the atmospheric pressure.

15. The method of claim 12, wherein:
the bank for liquid crystal injection has a polygon cross-sectional structure in which an end of the communication channel on one side thereof is an apex, and
in the exposing of the bank for liquid crystal injection to the atmospheric pressure, the bank for liquid crystal injection is exposed to the atmospheric pressure through the first opening of an incision line that is formed at opposite side of an apex of the bank for liquid crystal injection near the communication channel.

16. The method of claim 12, further comprising closing the communication channel between the bank for liquid crystal injection and the main filling area by a finishing sealant, after increasing the filling rate of the main filling area,
wherein in the closing of the communication channel, the communication channel is closed by forming a second opening for injecting the finishing sealant into the bank for liquid crystal injection, injecting the finishing sealant having a liquid phase through the second opening, and curing the finishing sealant.

17. The method of claim 16, further comprising separating the bank for liquid crystal injection from the main filling area by cutting the sealant line along an incision line that transects the communication channel.

18. The method of claim 12, further comprising:
separating the bank for liquid crystal injection from the main filling area by cutting the sealant line along an incision line that transects the communication channel; and
injecting a finishing sealant into an opening of the communication channel in order to close the opening the communication channel, which is exposed upon cutting.
